(19) United States
(12) Patent Application Publication
(10) Pub. No.: US 2015/0252761 A1
(43) Pub. Date: Sep. 10, 2015

(54) ACTUATION SYSTEM FOR PIEZOELECTRIC FUEL INJECTORS

(71) Applicant: Transonic Combustion, Inc., Camarillo, CA (US)

(72) Inventor: Scott Graves, Mountain View, CA (US)

(21) Appl. No.: 14/642,481

(22) Filed: Mar. 9, 2015

Related U.S. Application Data
(60) Provisional application No. 61/949,846, filed on Mar. 7, 2014.

(51) Int. Cl. F02M 51/06

(52) U.S. Cl. CPC F02M 51/0603

(57) ABSTRACT

Set forth herein are apparatus and systems that compensate for component dimensional changes in fluid control applications, particularly piezoelectric fuel injectors. Specifically, the present invention combines several functions to actuate an inward opening fuel injector with a piezoelectric stack. The arrangement can counteract expansion, amplify motion, compensate for dimensional variations, and/or compensate for fuel pressure variations. Some embodiments can reverse the expansion of the piezoelectric stack by converting it into a pulling force. Other embodiments can amplify and/or reduce component motion within the fuel injector to a desired motion ratio. The device can also compensate for dimensional variations of fuel injector components, such as thermal expansion, manufacturing tolerances, and/or component wear and alter the injector pin closing force based on the amount of fuel pressure.

### CROSS REFERENCE TO RELATED APPLICATIONS

This application claims the benefit of U.S. Provisional Patent Application Ser. No. 61/949,846, to Graves, filed on Mar. 7, 2014, and entitled “ACTUATION SYSTEM FOR PIEZOELECTRIC FUEL INJECTORS.”

### BACKGROUND OF THE INVENTION

1. Field of the Invention

The present invention relates generally to addressing changing forces in industrial engineering applications and more particularly to innovative actuators for piezoelectric inward opening fuel injectors.

2. Description of the Related Art

Fuel injectors used for in-cylinder injection in an internal combustion engine are required to rapidly open and close within a short period, in spite of extreme operating pressures and temperatures. Typical fuel injectors may use, for example, hydraulically or electromagnetically actuated injector pins. Additionally, piezoelectric actuators can be used, which have the fast response times necessary for use in modern fuel injectors.

The active element in piezoelectric actuators expand when they are electronically energized. More specifically, a piezoelectric element is a material that changes dimension when a voltage is applied across the element. Unfortunately, these types of actuators cannot be shock loaded or be put under too much tension because this may result in the actuator prematurely failing. Furthermore, the expansion of piezoelectric actuators is limited in travel, which limits potential fuel flow when used in a fuel injector. To increase this travel the piezoelectric elements can be stacked to correspondingly increase expansion length. However, there are limitations on the length of a piezoelectric stack based on the manufacturing process. Moreover, packaging long, slender piezoelectric stacks is also a challenge.

Inward opening fuel injectors require the pin to move inwards away from the nozzle seat, whereas outward opening injectors have the pin open away from the injector nozzle. Therefore, an injector pin that opens inward can be challenging to actuate with a piezoelectric element. Additionally, outward opening piezoelectric injectors can sometimes be used.

An additional concern with a long piezoelectric stack is the requirement for thermal compensation. For instance, the metal or other material which connects the end of the piezoelectric stack with the body of the fuel injector can expand due to temperature change. As a result, temperature changes can reduce or completely negate the expansion of the piezoelectric stack during deviations in temperature.

FIG. 1 is a cut away view of one example of a prior available fuel injector 100 showing several aspects of a fuel injector, including an injector pin 102, an inner housing 104, and an outer housing 106. The upper portion of the injector pin 102 is sealed by a seal assembly 110, which comprises an inner chamber 112, a main seal 114, and a backup seal 116. The main seal 114 can be any appropriate sealing mechanism. The backup seal 116 can function as a safety device in the event the main seal 114 fails. When the fuel injector is in a closed position, pressurized fuel can be pumped in through an input fuel port 120. Resilient elements or springs 122 help to bias the injector pin 102 in an upward direction. A flange section 126, which includes a cap portion 124, is on the injector pin 102 and forms a flat surface that contacts the piezoelectric elements or stacks 130. These piezoelectric elements or stacks 130 can be housed in a shuttle 132.

Several options can be used to actuate an injector pin. As discussed above, the injector pin can be outward opening. However, this has various issues associated with performance and manufacturing cost.

The injector pin can also be normally open. However, a loss in power to the piezoelectric stack can cause the injector pin to open on its own without any command, which can have devastating consequences. In turn, this can cause fuel to be discharged if a piezoelectric stack fails or if electrical power to the stack is interrupted. In addition, this configuration requires the piezoelectric stack to be energized most of the time, which reduces the longevity of the piezoelectric stack. As a result, the piezoelectric stack will have a much shorter life span based on the relatively high percentage of time it is energized. Thus, care must be taken during start up and shut down to coordinate the fuel pressure and piezoelectric energizing.

To solve the above injector problems, mechanical motion reversers can also be used, but they are susceptible to wear and require close attention to component tolerance issues. Also, direct coupling of the injector pin to the piezoelectric stack can cause shock loads to be more readily transmitted to the piezoelectric stack.

A piezoelectric actuator can also be used to open valves, by relieving pressure holding the injector pin closed. This will allow pressure from the fuel to open the injector pin. However, during closing, there is little control of the rate at which the pin closes, which can also result in the pin moving or bouncing. Additionally, a return line is required.

With regard to amplifiers, sufficient injector pin lift is associated with fuel flow requirements. In order to achieve the necessary pin lift, a long piezoelectric stack assembly is required. However, these long stacks are large, costly, and fragile when compared to shorter piezoelectric stacks.

Adding two or more piezoelectric stacks to gain the necessary pin lift is also an option, but this results in increased cost, packaging, and complexity. While mechanical amplifiers can be used, they have wear issues and are also have extremely sensitive tolerance issues. Additionally, pilot operations allow the injector pin to move freely until a defined stop. However, this results in little to no injector pin control during opening and/or closing.

Additionally, in order to allow for material expansion over the range of operating temperatures, a thermal compensator can be used. To compensate for this expansion of mechanical structures in the injector, many different exotic materials, such as Invar (a nickel-iron alloy), can be used. This requires a delicate balance between design and operating conditions to ensure that deviations are not too large to impact performance. Thermal compensators are also added to piezoelectric injectors as a separate assembly component. However, these compensators take up space and add to the overall length of the fuel injector. Moreover, they are costly and require precisely machined parts.

Finally, in order to increase the operating range of a fuel injector, it is desirable to increase and/or decrease the fuel pressure to the injector. Because there is a limited amount of time available between combustion cycles, increasing the duration is not always possible. Based on mechanical limitations of the fuel injector, there is a minimum response time for the injector opening and closing. Furthermore, changing the fuel pressure alters the internal force balance of the injector, so there is a limited range of pressures where the injector will function properly. As such, there is a present need for an assembly that allows the injector to operate effectively over a wide range of pressures.

Accordingly, there is a present need for a novel and efficient design for a piezoelectric fuel injector, which specifically addresses the aforementioned motion, amplifier, thermal compensation, and fuel pressure issues.

### SUMMARY

Described herein are apparatus and systems that account for component dimensional variation and other undesirable effects critical in fluid control applications, and more particularly piezoelectric fuel injectors. Specifically, systems according to the present invention combine several necessary functions to actuate an inward opening fuel injector with a piezoelectric stack. For instance, the presently described embodiments can compensate for expansion, dimensional variations, and/or fuel pressure variations, as well as amplify and/or reverse motion within piezoelectric fuel injectors.

In some embodiments, the device according to the present invention can provide a counter-movement to adjust for expansion of the piezoelectric stack, such as by converting it into a pulling force. In other embodiments, devices incorporating the present invention can amplify and/or reduce component motion within the fuel injector to a desired motion ratio. In yet other embodiments, the present assemblies can compensate for dimensional variations of fuel injector components, such as thermal expansion, manufacturing tolerances, and/or component wear. In other embodiments, the injector pin closing force can be altered based on the amount of fuel pressure. It is understood that the arrangements described herein can perform one or more of the above embodiments simultaneously.

These and other aspects and advantages will become apparent to those skilled in the art from the following detailed description and the accompanying drawings, which illustrate by way of example the features of the invention.

### BRIEF DESCRIPTION OF THE DRAWINGS

FIG. 1 is a longitudinal cross-sectional view of one example of a prior art piezoelectric fuel injector 100;

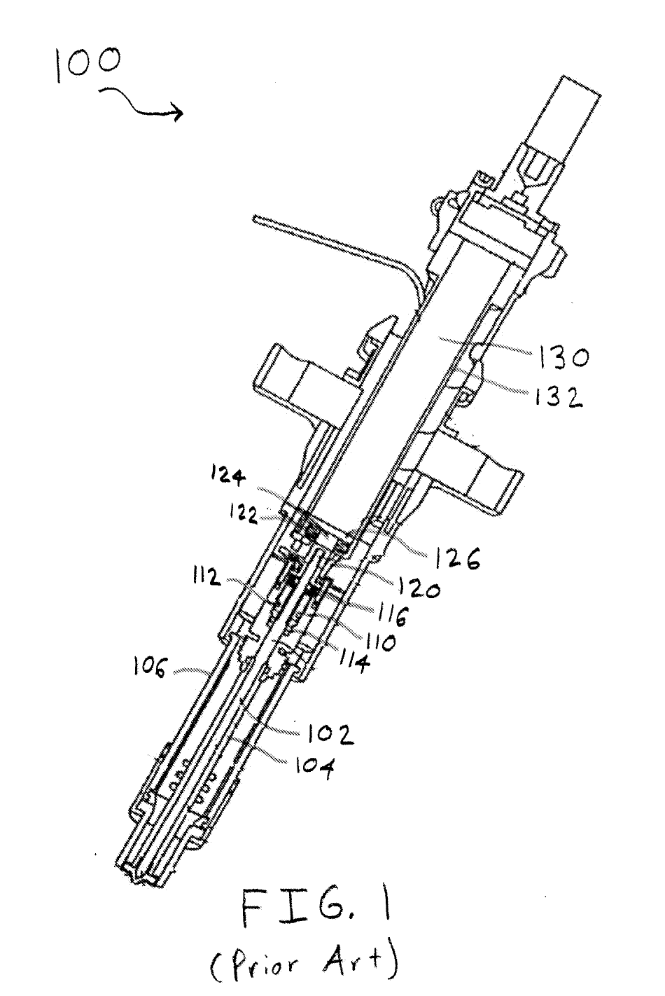

FIG. 2 is a longitudinal cross-sectional view of one embodiment of a piezoelectric fuel injector 200 incorporating features of the present invention;

FIG. 3 is an enlarged longitudinal cross-sectional view of the actuation portion of the piezoelectric fuel injector 200 incorporating features of the present invention;

FIG. 4 is an enlarged longitudinal cross-sectional view of the tip portion of the piezoelectric fuel injector 200 in an open state;

FIG. 5 is an enlarged longitudinal cross-sectional view of the tip portion of the piezoelectric fuel injector 200 in a closed state; and

FIG. 6 is a longitudinal cross-sectional view of another embodiment of a piezoelectric fuel injector 600 incorporating features of the present invention.

FIG. 7 is a longitudinal cross-sectional view of another embodiment of a piezoelectric fuel injector 700 incorporating features of the present invention.

### DETAILED DESCRIPTION

Described herein are apparatus and systems that account for component variation and other undesirable mechanical system changes. For instance, the present disclosure relates to actuator systems for use in mechanical systems, particularly fluid control applications and more particularly piezoelectric fuel injectors. Specifically, systems according to the present invention combine several necessary functions to actuate an inward opening fuel injector which utilizes a piezoelectric stack. For example, the present invention can perform a variety of functions, such as reversing the effect of expansion, amplifying motion, compensating for dimensional variations, and/or compensating for fuel pressure variations within piezoelectric fuel injectors.

In some aspects of the present invention, devices according to the present invention can reverse the effect of expansion of the piezoelectric stack, such as by converting it into a pulling force. In other embodiments, devices described herein can amplify and/or reduce component motion of a piezoelectric stack/fuel injector combination to provide a desired motion ratio. In yet other embodiments, the device incorporating features of the present invention can compensate for dimensional variations of fuel injector components, such as thermal expansion, manufacturing tolerances, and/or component wear. In other embodiments, the disclosed devices can alter the injector pin closing force based on the amount of fuel pressure. It is understood that the present invention can perform one or more of the above embodiments simultaneously.

Throughout this disclosure, the preferred embodiment and examples illustrated should be considered as exemplars, rather than as limitations on the present invention. As used herein, the term “invention,” “device,” “apparatus,” “method,” “present invention,” “present device,” “assemblies,” “present apparatus” or “present method” refers to any one of the embodiments of the invention described herein, and any equivalents. Furthermore, reference to various feature(s) of the “invention,” “device,” “apparatus,” “method,” “present invention,” “present device,” “present apparatus,” “present assembly” or “present method” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, it is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “outer,” “above,” “lower,” “below,” “horizontal,” “vertical” and similar terms may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. For example, when the present specification refers to “a” compensator, it is understood that this language encompasses a single compensator or a plurality or array of compensators. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

It is understood that the while the present disclosure makes reference to fuel injectors, and that piezoelectric fuel injectors within combustion systems are the primary application of the present disclosure, apparatuses incorporating features of the present invention can be utilized with other appropriate mechanical arrangements.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments described herein should not be construed as limited to the particular shapes of the regions illustrated herein but are to include deviations in shapes that result, for example, from manufacturing.

As previously indicated, the systems according to the present invention can be used in fuel injectors which utilize piezoelectric stacks or solenoids as actuators. The fuel injector can also comprise an injector pin and/or a nozzle. Specifically, the assemblies described herein can be mechanisms that can reverse and/or amplify the stroke of a piezoelectric stack as well as compensate for dimensional changes or variations caused by thermal fluctuations, fuel pressure, and/or other forces.

In some aspects, the systems can reverse the expansion of the piezoelectric stack, such as by converting it into a pulling force. In other embodiments, the present devices can amplify and/or reduce motion of components utilized with the fuel injectors to provide a desired motion ratio. In other embodiments, the present system can compensate for dimensional variations of fuel injector components, for example thermal expansion, manufacturing tolerances, and/or component wear. In other embodiments, the system can alter the injector pin closing force based on the amount of fuel pressure.

In a preferred arrangement, the present invention can embody a piezoelectric actuator interacting with a working piston. By doing so, the present device can transfer both force and piezoelectric motion. The working piston can be housed in a cylinder, which can be positioned closely around the piston. This working piston can also be in close proximity to a blind end. Furthermore, the working piston can feature an internal bore, and within the internal bore, there can be a second piston that is attached to the injector pin.

In some embodiments, a spring, or other force-generating device, can hold the injector pin in position. While holding the injector pin, this spring or other force-generating device can deliver force onto the top of the injector pin piston and/or the second piston in the blind bore within the working piston. Rearward pin movement is dampened by fluid pressure release. Specifically, fluid can release through vents opening at the rear of a backflow chamber. By doing so, fluid moving into and out of the backflow chamber creates a hydraulic dampening effect. A reservoir or hydraulic fluid storage chamber can refill the backflow chamber to compensate for any fluid leakage.

Additionally, the present invention can also comprise a working fluid. This working fluid can be utilized to fill all the areas between each piston. By doing so, the working fluid can transfer motion between the piston surfaces. Furthermore, the amplification ratio can be controlled by properly selecting the relative working piston area and injector pin piston working areas. However, the elastic properties of the various materials of construction and fluid contained in the system can result in a reduction of the amplification ratio.

Once actuated, the piezoelectric stack can extend and/or force the working piston into the fluid chamber. By doing so, this reduces the volume in the working chamber, which causes a corresponding increase in the chamber pressure. In turn, this causes a force to act on the injector pin piston, which lifts the injector pin against the preload spring force. As a result, the fluid in the working chamber can be under high pressure. Because the fluid is at a high pressure, it can leak past the close fitting pistons, thereby slightly reducing the volume of the fluid in the working chamber. However, as described above, because the injector opening times are very brief, the amount of fluid allowed to escape from the working chamber can be small.

To reverse the operation of the injector pin, the piezoelectric stack is de-energized. This de-energization causes the pressure in the working chamber to fall, which allows the return spring, or other force-generating device, to close the injector pin. All of the fluid that may have leaked past the close-fitting pistons, and hence may have exited the working chamber, can be refilled into the working chamber during the injector off time. If the injector off time is sufficient, then the working chamber can refill with fluid before the next desired injection event.

In modern high speed engines, with multiple injections per combustion cycle, the injector off time is normally insufficient to completely refill the working chamber with fluid before the next desired injection event. In order to address this, a check valve can be used, which allows the working chamber to be rapidly refilled with fluid.

Other embodiments of the present invention can increase the operating range of the fuel injector by increasing and/or decreasing the fuel pressure on the injector. The present device allows the fuel injector to operate effectively over a wide range of pressures without affecting the balance of forces on the injector valve. Specifically, the present invention can accomplish this through the use of a bellows. However, a bellows is not necessary to accomplish this, as any other device that is used to generate force with the application of pressure can suffice. The aforementioned bellows or other device can alter the pin closing force based on fuel pressure, so that the fuel pressure can increase and/or decrease without consequences.

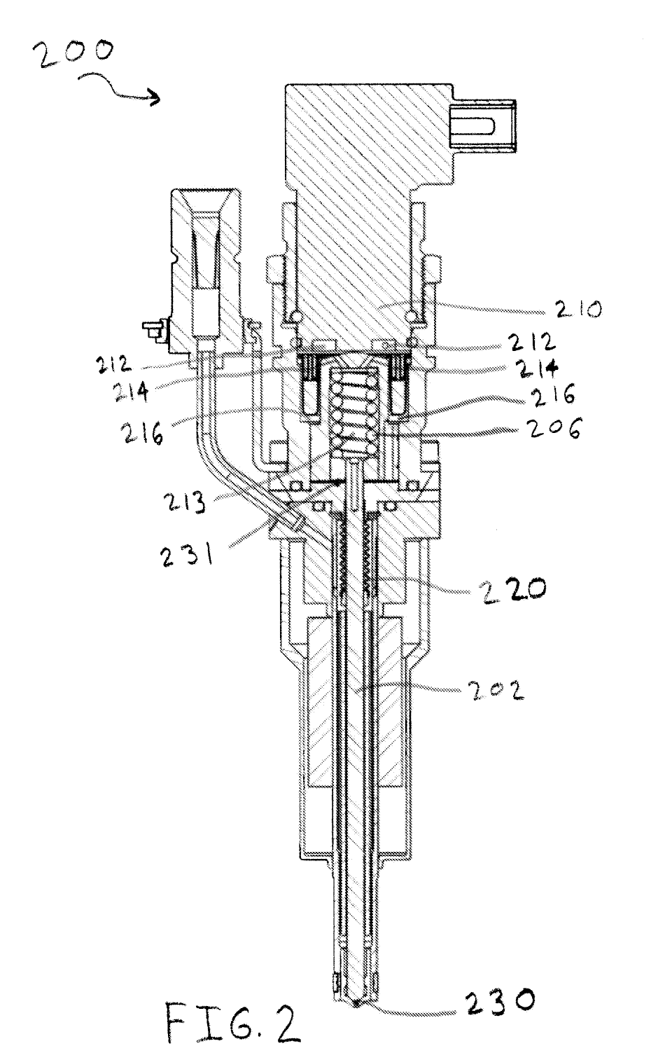

FIG. 2 is a longitudinal cross-sectional view of an embodiment of a piezoelectric fuel injector 200 incorporating features of the present invention. Fuel injector 200 comprises an injector pin 202, along with a spring 206. The injector pin 202 has a pin tip 230 at the fuel delivery end of fuel injector 200. Additionally, fuel injector 200 comprises piezoelectric stacks 210.

Rearward movement of the injector pin 202 is dampened by fluid pressure release from the spring chamber 213. Specifically, fluid can flow through bleed holes 214 and into backflow chambers 212. By doing so, fluid moving into and out of residual pressure chamber 216 creates a hydraulic dampening effect. Additionally, the hydraulic dampening effect can be altered by the size of the bleed holes 214. Residual pressure chamber 216 can provide fluid to refill the working chamber 231 to compensate for any fluid leakage.

As the injector pin 202 is actuated, there can be fluid leakage from the working chamber 231 into residual pressure chamber 216. As the injector pin 202 closes, fluid from the residual pressure chamber 216 refills the working chamber 231. Fuel injector 200 also comprises a pin bellows 220. The pin bellows 220 can keep the fuel contained and allow pin movements.

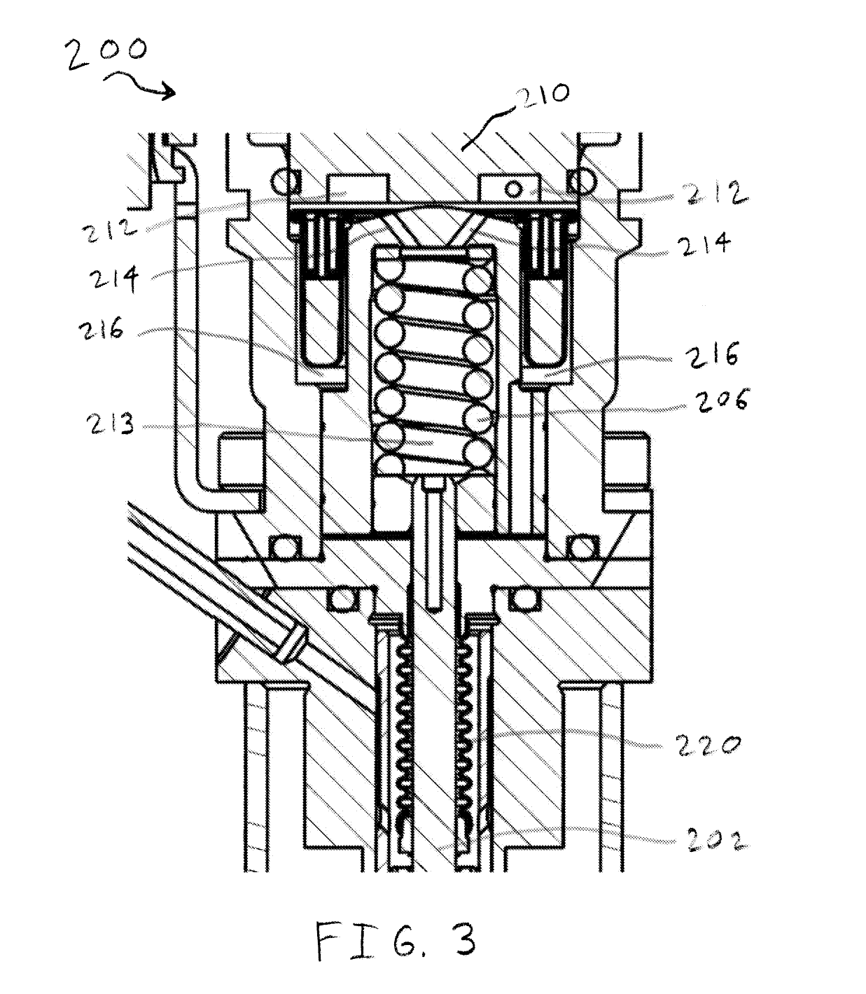

FIG. 3 is an enlarged view of the actuation portion of the piezoelectric fuel injector 200. Specifically, FIG. 3 exhibits a magnified view of injector pin 202, spring 206, spring chamber 213, piezoelectric stacks 210, backflow chambers 212, residual pressure chamber 216, and pin bellows 220.

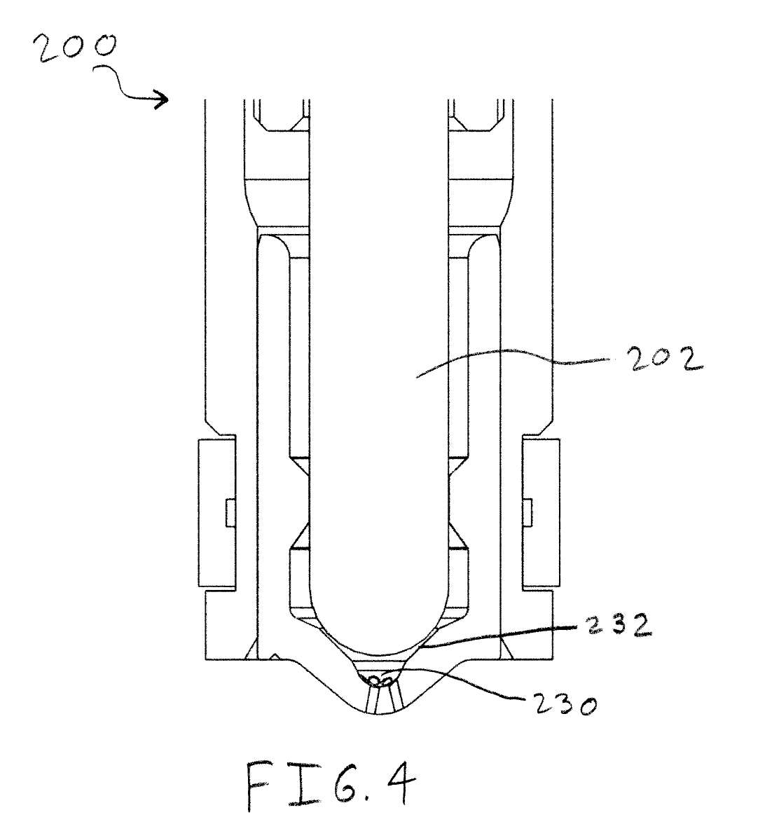

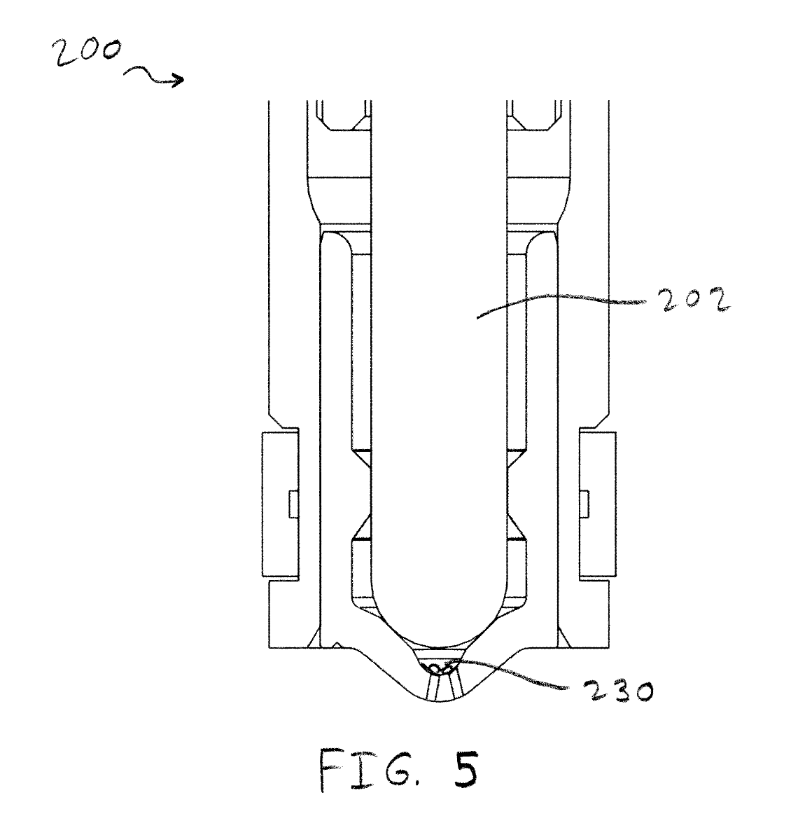

FIGS. 4 and 5 are enlarged views of the tip portion of the piezoelectric fuel injector 200. FIG. 4 shows fuel injector 200 in an open state. FIG. 4 comprises injector pin 202 and pin tip 230. FIG. 5 is also an enlarged view of the piezoelectric fuel injector 200, but in a closed state. Like FIG. 4, FIG. 5 comprises injector pin 202 and pin tip 230.

Although FIGS. 4 and 5 appear to be similar, there is a distinct difference. Specifically, in FIG. 5, the bottom of injector pin 202 and the inner upper surface of pin tip 230 are in contact so as to close off fuel flow. In FIG. 4, this area is open (see opening 232) to allow fuel flow. In this manner, fuel injector 200 in FIG. 4 is open, while the fuel injector 200 in FIG. 5 is closed. As such, fuel can flow through the pin tip 230 in FIG. 4 to deliver fuel to the combustion chamber. In contrast, fuel cannot flow through the pin tip 230 in FIG. 5.

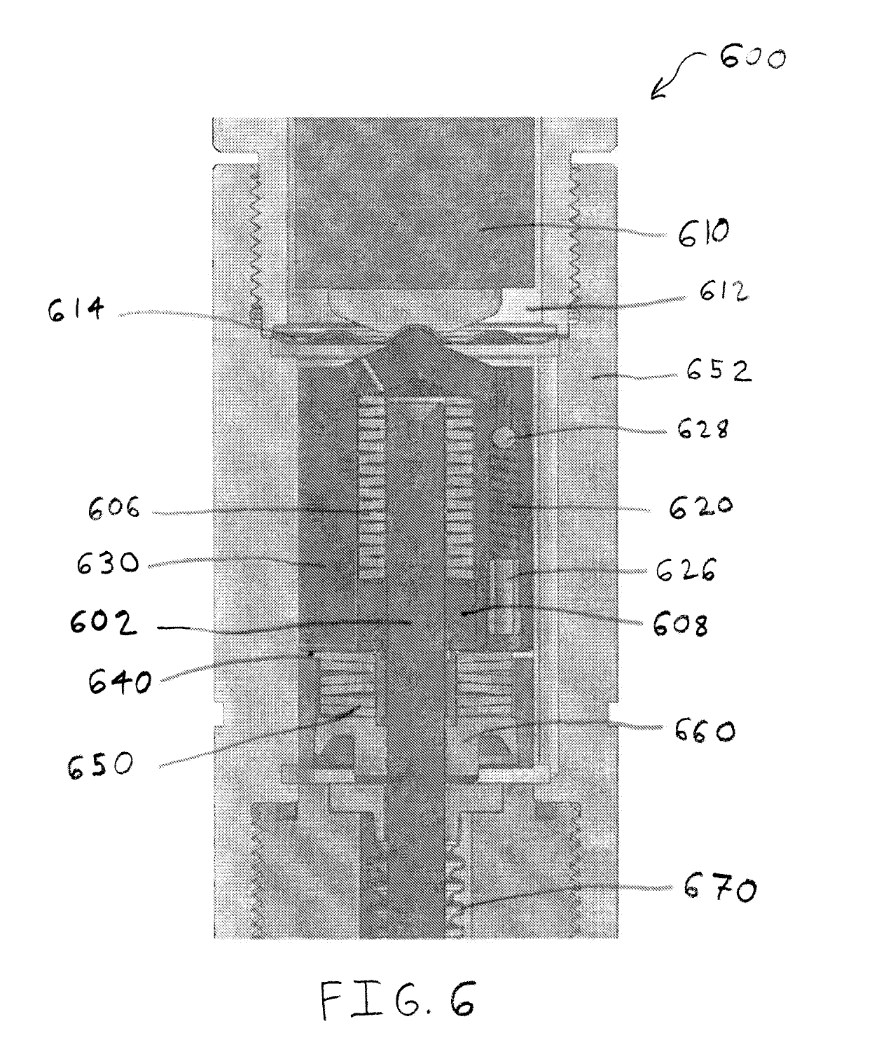

FIG. 6 is a longitudinal cross-sectional view of another embodiment of a piezoelectric fuel injector 600 incorporating features of the present invention. The fuel injector 600 can comprise an injector pin 602 located within a working piston 630. The injector pin 602 is shown held in a closed position by pin return springs 606, which are adjacent the pin piston 608. The fuel injector 600 also comprises piezoelectric elements or stacks 610 in an air-filled chamber 612 and above the working piston 630. Fuel injector 600 also comprises diaphragm 614.

Additionally, the working piston 630 interacts with the piezoelectric stacks 610 to help transfer force and motion. In other embodiments, a fluid can surround and fill all the areas in and around the working piston 630, as well as any additional pistons. In yet other embodiments, the working piston 630 can have an internal bore. Furthermore, fuel injector 600 can include a piston housing 652.

In addition, fuel injector 600 can comprise a check valve spring 620, a spring retainer 626, and a check ball 628. Fuel injector 600 can also comprise a working pressure chamber 640 and piezoelectric preload springs 650, along with a seal 660. Furthermore, fuel injector 600 can comprise a pin bellows 670 which can keep the fuel contained and allow pin movements.

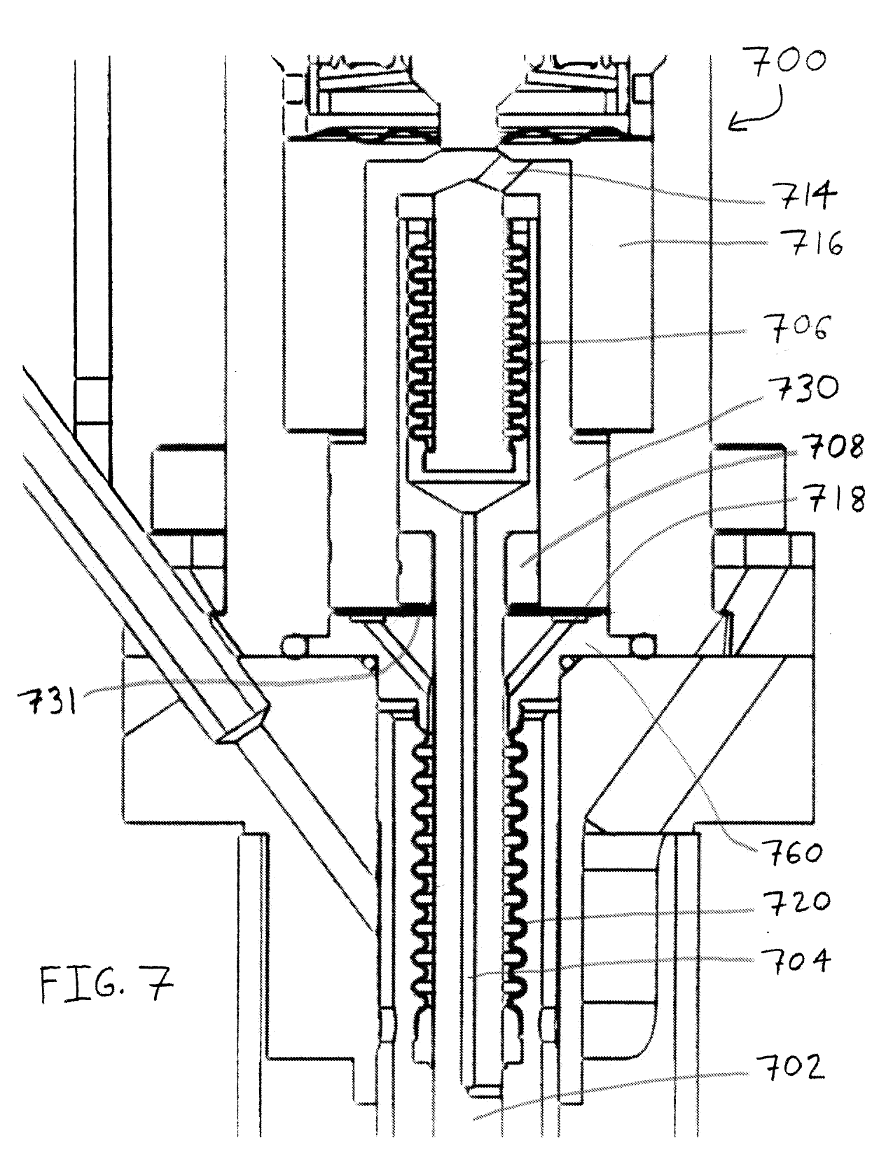

FIG. 7 is an enlarged longitudinal cross-sectional view of a variation of the embodiment in FIG. 2 showing a piezoelectric fuel injector 700 incorporating features of the present invention. Fuel injector 700 comprises injector pin 702 and fuel pressure transfer hole 704. Pin return bellows 706 can adjust the closing force of the injector pin 702 which allows the injector to operate effectively over a vast array of pressures. Pin bellows 720 can keep the fuel contained in the proper place and allow for pin movements.

Fuel injector 700 also comprises pin piston 708 and working piston 730. Additionally, fuel injector 700 includes bleed hole 714 and residual pressure chamber 716. Furthermore, fuel injector 700 comprises check valve 718, working chamber 731, and seal 760.

Pin return bellows 706 allows the fuel injector 700 to effectively operate over a vast array of pressures through the ability to adjust the closing force of the injector pin 702. In order to do so, pin return bellows 706 can alter the force generated on the injector pin 702, even if the pressure within the fuel injector 700 varies. The source of this pressure variation can be from a variety of causes, for example, fuel pressure and/or temperature. As such, the pin return bellows 706 allows the injector pin 702 to close at a constant force, no matter what the surrounding pressure may be within the fuel injector 700.

It is understood that embodiments presented herein are meant to be exemplary. Embodiments of the present invention can comprise any combination of compatible features shown in the various figures, and these embodiments should not be limited to those expressly illustrated and discussed.

Although the present invention has been described in detail with reference to certain configurations thereof, other versions are possible. Therefore, the spirit and scope of the invention should not be limited to the versions described above.

The foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

I claim:

1. An actuator system, comprising:
a housing;
a working piston within said housing;
one or more piezoelectric elements within said housing adjacent said working piston, wherein energizing said piezoelectric elements causes the elements to expand against said piston and move said working piston;
an injector pin positioned adjacent to and moveable by said working piston;
pin return springs adjacent said injector pin positioned to hold said injector pin in the position adjacent the working piston; and
a working chamber adjacent said working piston and said injector pin and positioned to receive said working piston.

2. The system of claim 1, wherein movement of said working piston into said working chamber increases the pressure in said working chamber.

3. The system of claim 2, wherein said increase in pressure in said working chamber is proportional to movement of said injector pin.

4. The system of claim 1, wherein a working fluid is located in said working chamber, the working chamber allowing and said working fluid to leak out of said working chamber under increased pressure.

5. The system of claim 1, wherein said housing is a cylinder having an internal bore.

6. The system of claim 1, further comprising preload springs adjacent said working chamber and a check valve spring adjacent said injector pin.

7. The system of claim 1, wherein de-energizing said piezoelectric elements acts to offset the effect of energizing of said piezoelectric elements.

8. The system of claim 1, wherein said injector pin has a pin tip.

9. The system of claim 8, wherein said pin tip is configured to be in an open state or closed state.

10. The system of claim 9, wherein said injector pin is configured for liquid flow there through when said pin tip is in an open state.

11. The system of claim 9, wherein pressure in said working chamber causes said open state or closed state in said pin tip.

12. The system of claim 8, wherein said injector pin is connected to a combustion chamber.

13. The system of claim 8, further comprising a pin bellows adjacent said injector pin.

14. The system of claim 13, wherein said pin bellows acts to vary the opening and closing force of said pin tip.

15. The system of claim 1, wherein said piezoelectric elements are within an air-filled chamber adjacent said working piston.

16. A method for actuating a fuel injector, comprising:
actuating one or more piezoelectric elements within a housing, wherein said actuation causes said piezoelectric elements to expand into a working piston adjacent said piezoelectric elements;
forcing said working piston to move into a working chamber adjacent said working piston, wherein said working piston movement is caused by said expansion of said piezoelectric elements so as to reduce the volume in said working chamber and increase the pressure in said working chamber;
an injector pin adjacent said working chamber being moved by said increase in pressure in said working chamber, said injector pin including an injector pin tip;
said injector pin tip caused to open by said increase in pressure in said working chamber.

17. The method of claim 16, further comprising de-energizing said piezoelectric elements, wherein said de-energizing causes an offset of said actuating of said piezoelectric elements.

18. An actuator system, comprising:
a spring chamber comprising a spring and a spring liquid;
one or more piezoelectric elements adjacent said spring chamber, wherein said piezoelectric elements actuatable to expand into and move said spring;
one or more backflow chambers adjacent said spring chamber, configured to allow said spring liquid to flow from said spring chamber into said backflow chambers;
an injector pin adjacent said spring chamber;
a working chamber adjacent said spring chamber and adjacent said injector pin.

19. The system of claim 18, said injector pin comprising a pin tip, wherein said pin tip changes from an open state to a closed state depending on the pressure in said working chamber.

20. The system of claim 18, further comprising one or more residual pressure chambers adjacent said working chamber.
